(19) United States
(12) Patent Application Publication
(10) Pub. No.: US 2007/0171059 A1
(43) Pub. Date: Jul. 26, 2007

(54) Security/monitoring electronic assembly for computers and assets

(76) Inventor: Antonio Pistilli, (US)

Correspondence Address: Antonio Pistilli, 2965 HEMINGWAY LANE, LEXINGTON, KY, 40513, US

(21) Appl. No.: 11/637,470

(22) Filed: Dec. 12, 2006

Related U.S. Application Data
(60) Provisional application No. 60/759,533, filed on Jan. 14, 2006.

(51) Int. Cl. G08B 13/14; G08B 1/08; G08B 21/00

(52) U.S. Cl. 340/568.1; 340/686.1; 340/539.1

(57) ABSTRACT

Securing and monitoring of a computer or asset against theft and vandalism can be achieved using an electronic assembly. Using sensors to monitor motion, vibration and light intrusion into the computer cavity, a decision is made to alert a remote surveillance station and trigger an audible alarm and/or disable the asset either permanently or temporarily through electronic means. The electronic assembly is a self-contained unit with battery backup capable of communicating to a central surveillance station over a LAN/WAN/Internet. A remote monitoring station linked to the Internet communicates to the asset(s) being monitored and provides an updated status to security personnel over any communications link deemed appropriate.

### CROSS-REFERENCE TO RELATED APPLICATIONS

This application claims priority under 35 U.S.C. 119(E) from U.S. Provisional Patent Application, Patent Application No. 60/759,533, filed on Jan. 14, 2006 which is, incorporated herein by reference in its entirety.

### FEDERALLY SPONSORED RESEARCH

not applicable

### SEQUENCE LISTING OF PROGRAM

not applicable

### BACKGROUND OF THE INVENTION

1. Field of Invention

This invention relates to the protection and monitoring of assets against theft, and vandalism of assets as well as providing capabilities for the management of said assets. The initial implementation is targeted but not limited to laptops, PCs, projectors and LCD displays.

2. Prior Art

Prior methods of protecting of computers and assets have relied on mechanically securing said devices to fixed objects. Although this may appear to provide some assurance, it can easily be foiled with appropriate tools. Vandalism and destruction of the property goes unchecked, as mechanical tethers will provide limited deterrence.

Other methods using electronic assemblies have been deployed. This would include simple electronic assemblies, which sound an alarm when a cable is removed. This can be circumvented as it relies on available power, which can be removed and does not alert any surveillance official remotely. This approach relies on a local authority within audible range to raise suspicion of a theft. Clearly this approach is of very limited value in its present state.

3. Objects and Advantages

Accordingly, several objects and advantages of the invention are:

(a) to provide an asset protection circuit (APC) residing in or within proximity of a computer, laptop or any asset being protected, herein referred to as Moveable Asset (MA);
(b) to provide an APC capable of detecting motion, vibration or abnormal situation indicative of a problem; (c) to provide an APC capable of detecting changes in light as would be the case should someone be opening the computer case;
(d) to provide an audible alert should a theft or act of vandalism be detected;
(e) to provide a means of generating an electrical signal that can be used to disable or destroy the asset based on predefined configuration;
(f) to provide a self contained communications link to a Communication Network (CN) for access to a Central Monitoring Unit (CMU). This communications link would be operational irrespective of the powered state of the MA;
(g) to provide a self contained communications capability which could be wired (Ethernet), wireless or fiber optic;
(h) to provide a power backup in the event that local power is unavailable;
(i) to provide a power management unit which can wakeup the electronic at pre-selected time intervals to ensure reliable and deterministic communications with the Central Monitoring Unit (CMU);
(j) to provide a wake up circuit to the power management unit should sensors detect an unauthorized activity. This wake up circuit will immediately wake up the main processor which would assess the situation and take appropriate action;
(k) to provide battery monitoring circuit in the event that the battery is getting low in charge, the processor can communicate this information to the Central Monitoring Unit (CMU) alerting it that no further communications will be forthcoming as the assembly will go into shutdown rather than operate outside of specification;
(l) to provide a bridge capability on the electronic assembly so that only one Ethernet cable is required to the external network. The computer's resident cable can be daisy chained to the said electronic assembly where the said assembly's own Ethernet traffic will be routed through the bridge's external port;
(m) to provide the capability to configure the Asset Protection Circuit remotely over a communications link;
(n) to provide the provisions in the Central Monitoring Unit to group one or more Moveable Assets into logical groupings so that they can be configured as a unit;
(o) to provide control through a Central Monitoring Unit to control the Asset Protection Circuit directly or automatically based on inputs or a time schedule. This is used to set alarm activation times, thresholds and other such parameters.

Still further objects and advantages will become apparent from a consideration of the ensuing description and drawings.

### SUMMARY

In accordance with the invention, an electronic assembly comprising sensors for motion and light with audible alert and communications facilities. Said assembly will have self-contained communications capabilities and battery backup with power management capability. Said assembly will communicate with a Central Monitoring Unit over the Internet, LAN, WAN or other communications facility.

### DRAWINGS

FIGS. 1A and 1B is a high level overview of an application of the present invention.

FIG. 2A/B is a system level description of the preferred embodiment of the present invention.

FIG. 3 is an exemplary embodiment in accordance with the invention.

FIG. 4 is an exemplary embodiment of the Moveable Asset (MA), Asset Protection Circuit (APC) and Power.

FIG. 5 is a block level description of the Asset Protection Circuit (APC).

FIG. 6 is a flow chart of the Method to claim 15.

### REFERENCE NUMERALS

| | |
|---|---|
| 105 | Central Monitoring Unit (CMU) |
| 106 | Communications link |
| 110 | Communications Network (CN) |
| 111 | Communications link |
| 112 | Communications link |
| 115 | Moveable Asset (MA) |
| 120 | Asset Protection Circuit (APC) |
| 121 | Communications Link |
| 122 | Communications Link |
| 123 | Communications Link |
| 125 | Moveable Asset (MA) |
| 205 | Central Monitoring Unit (CMU) |
| 206 | Communications Link |
| 207 | Communications Link |
| 208 | Communications Link |
| 209 | Communications Link |
| 210 | Communications Network (CN) |
| 211 | Communications Link |
| 212 | Communications Link |
| 215 | Computer |
| 216 | Communications Link |
| 217 | Communications Link |
| 218 | Communications Link |
| 220 | Asset Protection Circuit (APC) |
| 225 | Computer |
| 230 | Laptop |
| 235 | Laptop |
| 305 | Wireless Router |
| 405 | Battery |
| 410 | AC Power Source |
| 505 | Motion Detector |
| 510 | Light Sensor |
| 515 | Audible Alarm |
| 520 | Timer |
| 525 | Battery |
| 530 | Power |
| 535 | Power Management |
| 540 | Ethernet Bridge |
| 545 | Micro Controller |
| 550 | Communications Port |
| 555 | Communications Port |
| 605 | Method Claim 15 |
| 610 | Method Claim 15 |
| 615 | Method Claim 15 |
| 620 | Method Claim 15 |

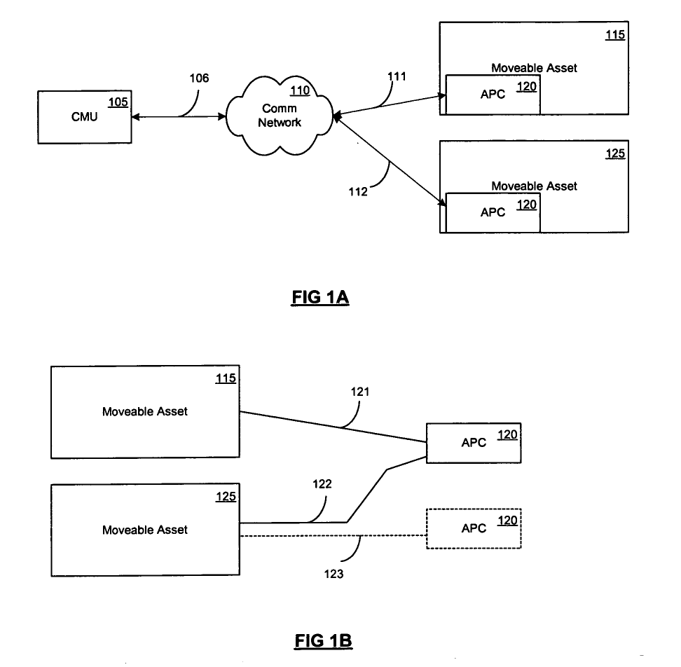

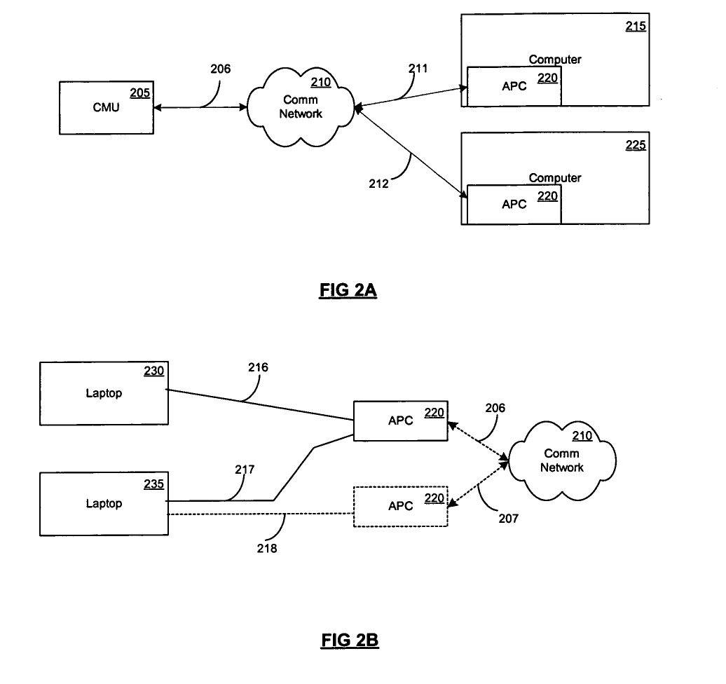

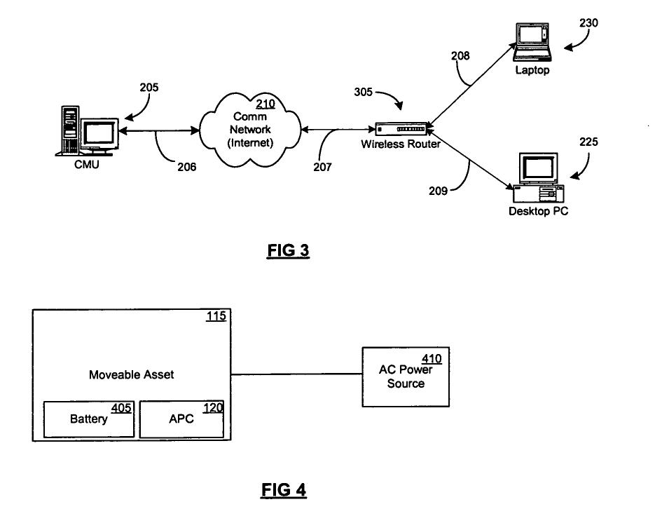

### DETAILED DESCRIPTION—FIGS. 1 AND 2—PREFERRED EMBODIMENT

An exemplary embodiment of the present invention is illustrated in FIG. 1A. The preferred embodiment comprises a Central Monitoring Unit (105) with Moveable Assets (MA)(115/125) secured with the Asset Protection Circuit (APC)(120). The APC monitors the MA for Unauthorized Access (UA) and relates this information over the Communications Network (CN) (110). FIG. 1B presents another exemplary embodiment where the APC (120) is external to the MA (115, 125) but linked through a Communications Link (121, 122, 123).

A further exemplary embodiment is provided in FIG. 2A/B where a specific instance of a MA is identified as a Computer (215, 225) and a Laptop (230, 235).

FIG. 3 is an additional exemplary embodiment extending the CN (210) to include a wireless router (305) protecting MA(s). The MA being a Laptop (230) and a Desktop Computer (225).

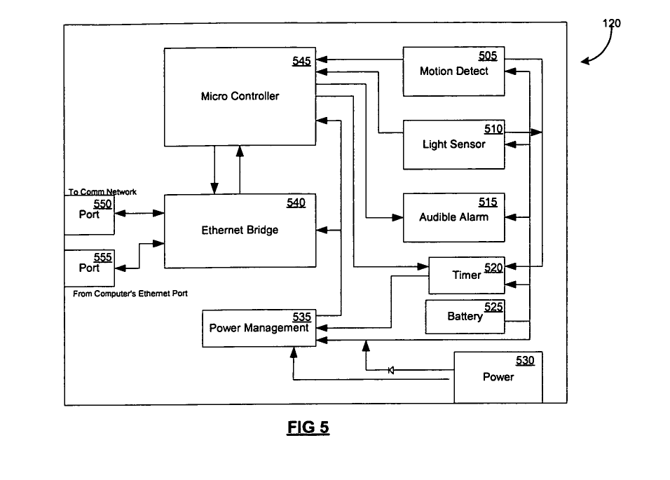

An exemplary embodiment of the configuration of MA (115), APC (120) and power (410) is highlighted in FIG. 4. A power source (410) provides power to the MA (115) and Batteries (405) provide backup to the APC (120) in the event of a power outage.

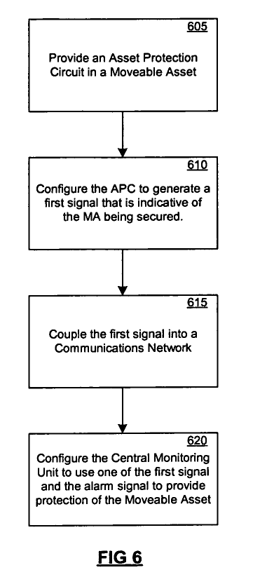

An exemplary embodiment of the APC is provided in FIG. 5. It comprises of a Motion Detector (505), Light Sensor (510) and Audible Alarm (515) interfacing with the Micro Controller (545). These are used to alert in the event of an UA where the sensors provide the means of detection for the UA. An Ethernet Bridge (540) and two communication ports (550) and (555) provide the Communications Capabilities to the CMU. Power entry into the APU is detailed in the Power block (530). This can be provided by Backplane power, a power outlet or from the MA. Power Management capabilities (535) monitor incoming power and the internal batteries (525). In the event of incoming Power being inadequate, the Power Management (535) will further engage the Batteries (525) and Timer Module (520) to selectively engage the APC (120) into Sleep mode with periodic wakeup intervals. Should an UA be detected during this Sleep Mode, the sensors (505, 510) can bring the APC out of Sleep Mode.

FIG. 6 is a block diagram of the Methods of claim 15. Item 605 is the basic claim. Block 610 further claims a first signal generation as an indication of the MA being secured. Block 615 ties this signal into the Communications Network. Block 620 ties this signal to a Central Monitoring Unit CMU protecting the Moveable Asset.

Additional embodiments of the present design would include the use of additional sensors on the electronic assembly to monitor external or internal parameters. An example of such a sensor would be temperature, pressure, humidity, velocity, smoke and/or Global Position Sensor (GPS).

### CONCLUSION, RAMIFICATION AND SCOPE

Accordingly, the reader will see the potential of monitoring assets using sensory information remotely with integrated communications capabilities. By not relying on the asset for power or provisions for communications, reliable monitoring of assets against theft and vandalism can be achieved. Information can be transmitted quickly and reliably to the monitoring station where additional actions can be initiated either manually or automatically. Such actions can include but are not limited to sending an email notification, placing a cellular call with prerecorded message or constructed messages, placing a phone call over existing land lines, and/or sending a message over a satellite link. Utilizing the asset's communications capability as per prior art seriously compromises the security of the asset against theft or vandalism.

Although the description above contains much specificity, these should not be construed as limiting the scope of the invention but as merely providing illustrations of some of the presently preferred embodiments of this invention. Thus the scope of the invention should be determined by the appended claims and their legal equivalents rather than by the examples given.

I claim:

1. An asset protection system, comprising:
a moveable asset;
an asset protection circuit coupled to the moveable asset, the asset protection circuit configured to periodically generate a first signal when the moveable asset is secure and to communicatively couple the first signal into a communications network, the asset protection circuit further configured to generate an alarm signal when an unauthorized activity is carried out upon the moveable asset and to communicatively couple the alarm signal into the communications network; and
a central monitoring unit operable to provide a protection service of the moveable asset by receiving at least one of the first signal and the alarm signal from the communications network.

2. The asset protection system of claim 1, wherein the moveable asset comprises an electronic circuit powered by a battery.

3. The asset protection system of claim 2, wherein the asset protection circuit comprises a motion detector circuit powered at least in part by the battery, the motion detector circuit configured to detect an unauthorized movement of the moveable asset and generate in response thereof, a first signal for triggering generation of the alarm signal.

4. The asset protection system of claim 3, wherein the asset protection circuit further comprises a light sensor configured to detect an unauthorized disassembling of at least a part of the moveable asset and generate in response thereof, a second signal for triggering generation of the alarm signal.

5. The asset protection system of claim 4, wherein the moveable asset is one of a) a laptop computer, b) a desktop computer, c) a communications device, and d) an electromechanical device.

6. The asset protection system of claim 2, wherein the electronic circuit is normally coupled to an AC power source and selectively coupled to the battery upon failure of the AC power source.

7. The asset protection system of claim 2, wherein the asset protection circuit comprises a sleep timer configured to selectively place the asset protection circuit in a sleep mode of operation.

8. The asset protection system of claim 7, wherein the sleep timer is further configured to selectively terminate the sleep mode of operation and place the asset protection circuit in a normal mode of operation.

9. The asset protection system of claim 1, wherein the communications network is one of a) the Internet, b) a local area network (LAN), and c) a wide area network (WAN).

10. An asset protection system, comprising:
a computer;
an asset protection circuit located in the computer, the asset protection circuit configured to periodically generate a first signal when the computer is secure and to communicatively couple the first signal into a communications network, the asset protection circuit further configured to generate an alarm signal when an unauthorized activity is carried out upon the computer and to communicatively couple the alarm signal into the communications network; and
a central monitoring unit operable to provide a protection service of the computer by receiving at least one of the first signal and the alarm signal from the communications network.

11. The asset protection system of claim 10, wherein the computer is powered at least in part, by a battery.

12. The asset protection system of claim 11, wherein the asset protection circuit comprises one of a) a motion detector circuit configured to detect an unauthorized movement of the computer and generate in response thereof, a first signal for triggering generation of the alarm signal and b) a light sensor configured to detect an unauthorized disassembling of at least a part of the computer and generate in response thereof, a second signal for triggering generation of the alarm signal.

13. The asset protection system of claim 12, wherein the computer is one of a laptop computer and a desktop computer; and the communications network is one of a) the Internet, b) a local area network (LAN), and c) a wide area network (WAN).

14. The asset protection system of claim 13, wherein the asset protection circuit comprises a sleep timer configured to place the asset protection circuit in a sleep mode of operation when the computer is in an inactive state for a first period of time and to terminate the sleep mode of operation when the computer is in an active state.

15. A method of protecting a moveable asset, the method comprising:
providing an asset protection circuit in the moveable asset;
configuring the asset protection circuit to generate a first signal that is indicative of the moveable asset being secure;
coupling the first signal into a communications network;
detecting an unauthorized activity carried out upon the moveable asset and generating in response thereof, an alarm signal;
coupling the alarm signal into the communications network;
providing a central monitoring unit;
configuring the central monitoring unit to receive one of the first signal and the alarm signal from the communications network; and
configuring the central monitoring unit to use one of the first signal and the alarm signal to provide protection of the moveable asset.

16. The method of claim 15, wherein the moveable asset comprises an electronic circuit powered by a battery.

17. The method of claim 16, wherein the moveable asset is one of a) a laptop computer, b) a desktop computer, c) a communications device, and d) an electromechanical device.

18. The method of claim 16, further comprising:
placing the asset protection circuit in a sleep mode of operation when the moveable asset is in an inactive state for a first period of time; and
terminating the sleep mode of operation when the moveable asset transitions to an active state.

19. The method of claim 18, further comprising:
periodically transitioning out of the sleep mode of operation for transmitting the first signal.

20. The method of claim 19, further comprising:
periodically transitioning out of the sleep mode of operation for detecting the unauthorized activity carried out upon the moveable asset; and
transmitting the alarm signal upon detection of the unauthorized activity.
